(19) United States
(12) Patent Application Publication
(10) Pub. No.: US 2024/0101179 A1
(43) Pub. Date: Mar. 28, 2024

(54) ONE-HAND FOLDING STROLLER

(71) Applicant: Britax Child Safety, Inc., Fort Mill, SC (US)

(72) Inventors: Angela Stacey, Fort Mill, SC (US); Huang Kai Yu, Fort Mill, SC (US); Yang Po Wen, Fort Mill, SC (US)

(21) Appl. No.: 18/369,570

(22) Filed: Sep. 18, 2023

Related U.S. Application Data
(60) Provisional application No. 63/409,337, filed on Sep. 23, 2022.

(51) Int. Cl. B62B 7/06; B62B 7/04; B62B 7/08

(52) U.S. Cl. CPC B62B 7/064; B62B 7/044; B62B 7/083; B62B 2205/003; B62B 2205/20

(57) ABSTRACT

Systems and methods for a stroller with a one-hand collapsing mechanism in accordance with embodiments of the inventions are disclosed. In a first aspect of the present disclosure, a folding stroller includes a collapsible frame, at least one wheel in a front part of the collapsible frame, at least one wheel in a rear part of the collapsible frame, at least one folding hinge coupled to the collapsible frame, a seating area having a seat portion and a back portion, and a release handle in the seat portion of the seating area, the release handle configured to be actuated with a one hand action, wherein the release handle is coupled to the at least one folding hinge, wherein the release handle is accessible through the seating area, and wherein actuating the handle causes the frame to transform from a deployed position to a collapsed position.

### PRIORITY CLAIM AND CROSS-REFERENCE TO RELATED APPLICATIONS

The present application claims priority and benefit of U.S. Provisional Patent App. No. 63/409,337 filed Sep. 23, 2022, titled ONE-HAND FOLDING STROLLER, entire contents of which are incorporated by reference herein and relied upon.

### TECHNICAL FIELD

The present invention generally relates to strollers, and more specifically to foldable strollers.

### BACKGROUND

Strollers are wheeled devices used to transport passengers, which are often children. The seating mechanisms in strollers can vary. Similarly, passenger capacity and seat configuration can vary between strollers.

### SUMMARY

Systems and methods for a stroller with a one-hand collapsing mechanism in accordance with embodiments of the inventions are disclosed. In a first aspect of the present disclosure, a folding stroller includes a collapsible frame, at least one wheel in a front part of the collapsible frame, at least one wheel in a rear part of the collapsible frame, at least one folding hinge coupled to the collapsible frame, a seating area having a seat portion and a back portion, and a release handle in the seat portion of the seating area, the release handle configured to be actuated with a one hand action, wherein the release handle is coupled to the at least one folding hinge, wherein the release handle is accessible through the seating area, and wherein actuating the handle causes the frame to transform from a deployed position to a collapsed position.

In a second aspect of the present disclosure, the rear wheels are located a first distance from the frame when the frame is in a deployed position and the rear wheels are located a second distance from the frame in the collapsed position, where the second distance is less than the first distance.

In a third aspect of the present disclosure, the seat portion of the seating area is coupled to the release handle.

In a fourth aspect of the present disclosure, the release handle engages with the seating portion to lock the seating area in place.

In a fifth aspect of the present disclosure, the collapsible frame comprises at least one folding hinge.

In a sixth aspect of the present disclosure, the at least one folding hinge comprises a mating member and a hinge plate.

In a seventh aspect of the present disclosure, including a slide lock that slidably couples to the release handle.

In an eighth aspect of the present disclosure, the slide lock has a locked configuration where the slide lock engages with the release handle to prevent release handle actuation and the slide lock has an unlocked configuration where the slide lock does not engage with the release handle and does not prevent release handle actuation.

In a ninth aspect of the present disclosure, the slide lock is toggled between the locked configuration and the unlocked configuration by sliding the slide lock from one side to another side.

In a tenth aspect of the present disclosure, including a handle spring that couples to the release handle such that tension in the handle spring orients the release handle in a first position.

In an eleventh aspect of the present disclosure, the release handle is actuated by engaging the release handle at the first position to overcome the tension in the handle spring such that the release handle moves to a second position.

In a twelfth aspect of the present disclosure, a folding stroller release handle assembly including a release handle coupled to a stroller seat frame, a handle spring coupled to the stroller seat frame and the release handle, and a handle lock. Actuating the release handle causes the stroller seat frame to transform from a deployed position to a collapsed position.

In a thirteenth aspect of the present disclosure, the release handle has a front portion and a rear portion.

In a fourteenth aspect of the present disclosure, the front portion of the release handle can be accessed through an aperture in a seat bottom that is coupled to the stroller seat frame.

In a fifteenth aspect of the present disclosure, the back portion of the release handle couples to the stroller seat frame so as to allow the release handle to move about a seat bottom that is coupled to the stroller seat frame.

In a sixteenth aspect of the present disclosure, tension from handle spring orients the release handle in a rear-most position relative to the seat bottom. When the release handle is in the rear-most position relative to the seat bottom a set of handle engagement members in the release handle engage with the stroller seat frame so as to prevent the release handle from moving about the seat bottom.

In a seventeenth aspect of the present disclosure, the release handle is actuated by engaging the release handle at the rear-most position relative to the seat bottom so as to overcome the tension in the handle spring such that the release handle moves to a front-most position relative to the seat bottom and concurrently the set of handle engagement members in the release handle disengage from the stroller seat frame such that the release handle can move about the seat bottom.

In an eighteenth aspect of the present disclosure, the handle lock is a slide lock that has a locked configuration where the slide lock engages with the release handle to prevent release handle actuation and the slide lock has an unlocked configuration where the slide lock does not engage with the release handle and does not prevent release handle actuation.

In a nineteenth aspect of the present disclosure, sliding the slide lock to a locked configuration prevents the release handle actuation.

In a twentieth aspect of the present disclosure, a method for folding a foldable stroller that includes a collapsible frame, at least one wheel in a front part of the collapsible frame, at least one wheel in a rear part of the collapsible frame, at least one folding hinge coupled to the collapsible frame, a seating area having a seat portion and a back portion, and a release handle in the seat portion of the seating area. The method includes actuating the release handle and pivoting the release handle about the collapsible frame such that the collapsible frame transforms from a deployed position to a collapsed position.

Other objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the claims.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIGS. 1A-C are illustrations of a one-hand folding stroller in accordance with embodiment of the invention;

FIGS. 2A-B are illustrations of a foldable seat assembly in accordance with embodiments of the invention;

FIGS. 3A-C are illustrations of release handle assemblies in accordance with embodiments of the invention;

FIGS. 4A-B are illustrations of a hinge assembly in accordance with embodiments of the invention;

FIGS. 5A-B are illustrations of a one-hand folding action for a one-hand folding stroller in accordance with embodiments of the invention;

FIG. 6 is an illustration of the operation of a release handle for a one-hand folding stroller in accordance with embodiments of the invention; and

FIG. 7 is an illustration of the operation of a release handle for a one-hand folding stroller in accordance with embodiments of the invention.

### DETAILED DESCRIPTION

Turning now to the drawings, systems and methods for a stroller with a one-hand collapsing mechanism in accordance with embodiments of the inventions are disclosed. Strollers are wheeled, user-pushed vehicles generally used to transport children in a seated position. The number of wheels and seat configurations can vary between strollers. For example, some strollers can have rear-facing seats, while others can have forward-facing seats. Similarly, some strollers have four wheels, while other strollers have three wheels. As another variation, some strollers have non-collapsible frames, while other strollers have collapsible frames. For folding stroller frames, users often have to engage with multiple locking parts such as clips, handles, straps and hinges, among other parts, in order to fold the stroller frame for ease of storage. As such, folding the stroller often requires both user hands to engage with the various locking parts. Moreover, folding the stroller often takes multiple steps, such as first unlocking the seat portion and then unlocking the stroller frame.

Strollers in accordance with embodiments of the invention include a one-hand folding mechanism. The frame collapsing mechanism includes a release handle located on the stroller seat. The release handle couples with one or more frame hinge mechanisms on the stroller frame. When the user engages the release handle, for example by pushing or sliding the release handle, the user unlocks the seat folding mechanism and the frame hinge mechanism simultaneously. As such, the user can transition the stroller from deployed position to collapsed position with the use of the release handle. In a variety of embodiments, the rear wheels retract towards the stroller frame when the stroller transitions from deployed position to the collapsed position.

In this way, one-hand folding strollers in accordance with embodiments of the invention are significant improvements over existing designs. For example, the one-hand folding mechanism allows users to fold the stroller frame using a singular step with the use of one hand. Existing designs typically use multiple steps, such as first unlocking the seat and/or engaging multiple folding hinges with the use of both hands. Also, one-hand folding strollers, when in the collapsed position, are more compact than the typical designs, thereby improving the ease of transporting and/or storing the one-hand folding stroller.

Systems and methods for strollers with a one-hand collapsing mechanism in accordance with embodiments of the invention are described in more detail below.

### One-Hand Folding Stroller

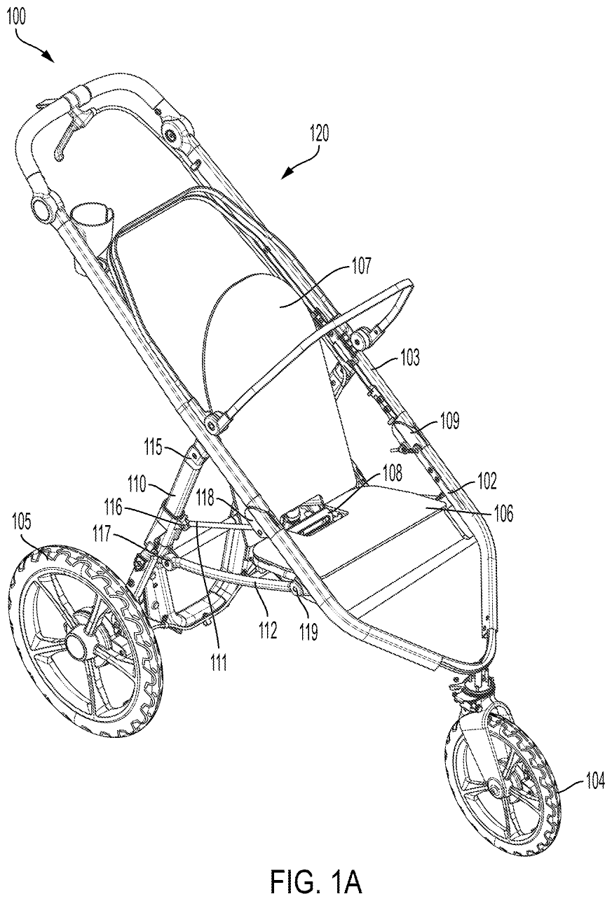

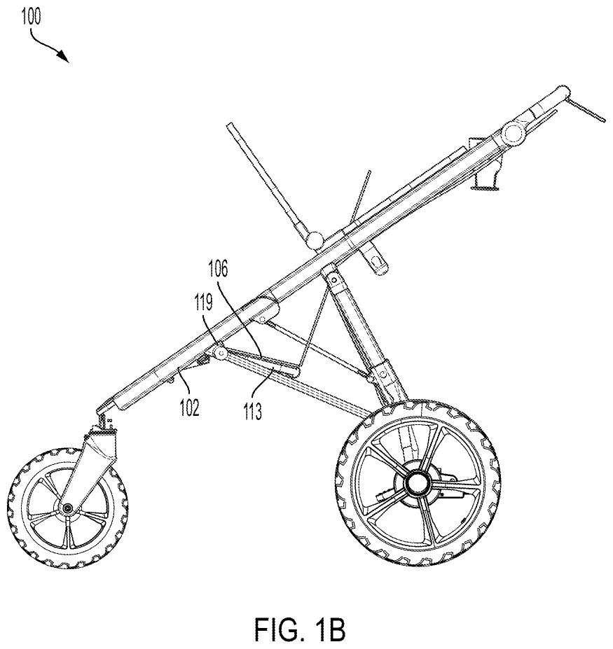

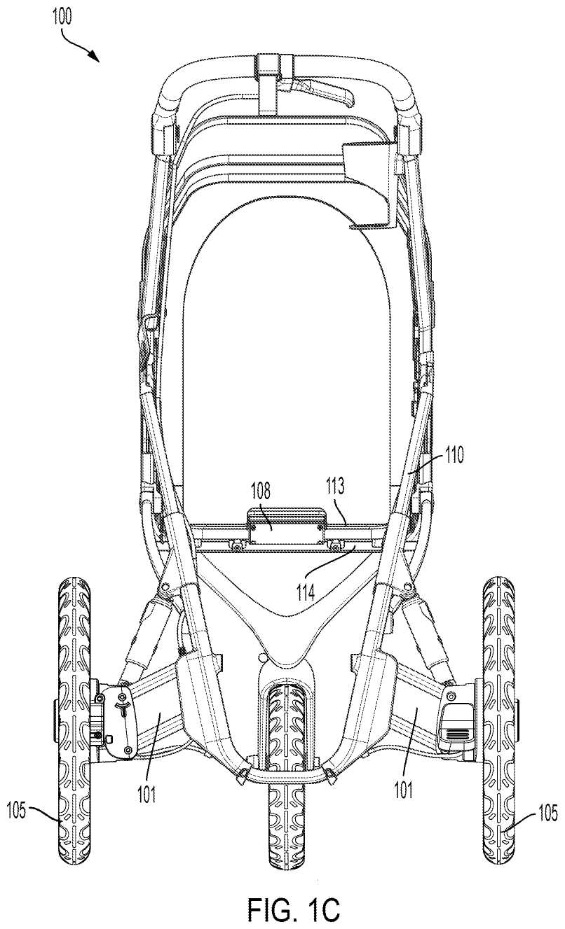

FIGS. 1A-C are renderings of a one-hand folding stroller in accordance with embodiments of the invention. Turning now to FIG. 1A, a perspective view of a stroller is shown. The stroller 100 includes a collapsible frame 120 with at least one front wheel 104 coupled to a front portion of the collapsible frame 120 and at least one removable rear wheel 105 coupled to a rear portion of the collapsible frame 120. In a variety of embodiments, the front wheel(s) 104 and/or rear wheel(s) 105 are removably coupled to the stroller 100. The collapsible frame 120 includes left and right upper members 103, a lower member 102, left and right rear members 110, left and right top rods 111, and left and right bottom rods 112. In the front of the collapsible frame 120, the left upper member 103 couples with the top left side of the lower member 102 via a left folding hinge 109 and the right upper member 103 couples with the top right side of the lower member 102 via a right folding hinge 109. The bottom of the lower member 102 couples with the removable front wheel(s) 104. The top of the left rear member 110 couples to the left upper portion 103 at a left upper fold point 115 and the top of the right rear member 110 couples to the right upper portion 103 at a right upper fold point 115. The bottom of the left and right rear members 110 each couple to one or more rear wheel assembly 105.

The left top rod 111 couples with the left hinge 109 at the left hinge point 118 on a first end, and the left rear member 110 at the left back fold point 116 on a second end. The right top rod 111 couples to the right side of collapsible frame 120 in the same way. Additionally, the left bottom rod 112 couples with the left side of the lower member 102 at the left lower fold point 119 on a first end, and the left rear member 110 at the left support fold point 117 on a second end. The right bottom rod 112 couples to the right side of collapsible frame 120 in a similar manner.

The stroller 100 has a seating area that includes a seat bottom 106 and a seat back 107 located between the left and right sides of the collapsible frame 120. A release handle 108 is coupled to the seat bottom 106.

Turning now to FIG. 1B, a side view of the stroller 100 is shown. As shown in FIG. 1B, the stroller 100 includes a seat frame 113 that couples to the lower member 102 at the lower fold point 119. Additionally, the seat bottom 106 couples to the seat frame 113 via screws or fasteners, for example.

Turning now to FIG. 1C, a rear view of stroller 100 is shown. As shown in FIG. 1C, a support crossbar 114 is located between the left and right side of the stroller 100 below the rear of the seat frame 113. In several embodiments, the seat frame 113 rests on the support crossbar 114. In a variety of embodiments, left and right removable rear wheels 105 each couple with a respective left and right wheel retraction assembly 101. The left and right wheel retraction assemblies 101 couple with the left and right rear members 110, respectively. Each wheel retraction assembly 101 includes one or more axles pivoting with respect to a corresponding rear member and a piston moving with respect to the corresponding rear member as the stroller 100 converts between a deployed position and a collapsed position.

It should be noted that the components of stroller 100 can be made from a variety of materials including steel, aluminum, plastics, carbon fiber, fiberglass, and/or any other material of a suitable weight, strength, and durability. A variety of materials and/or combinations of materials can be utilized as appropriate to the requirements of specific applications of embodiments of the invention.

FIGS. 1A-C are illustrative embodiments of a folding stroller and many configurations are appropriate. For example, a number of folding strollers, including those that use alternative elements to couple the front and rear of the stroller and those without retractable wheels, can be utilized as appropriate to the requirements of specific applications of embodiments of the invention.

### Foldable Seat Assemblies

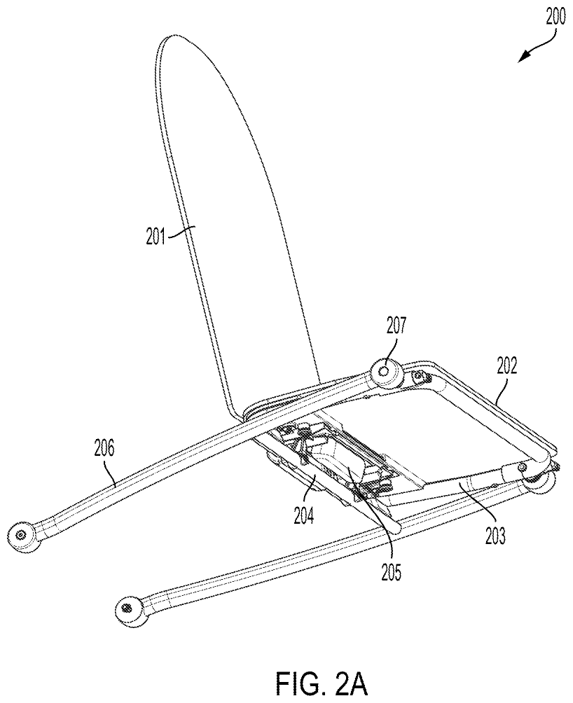

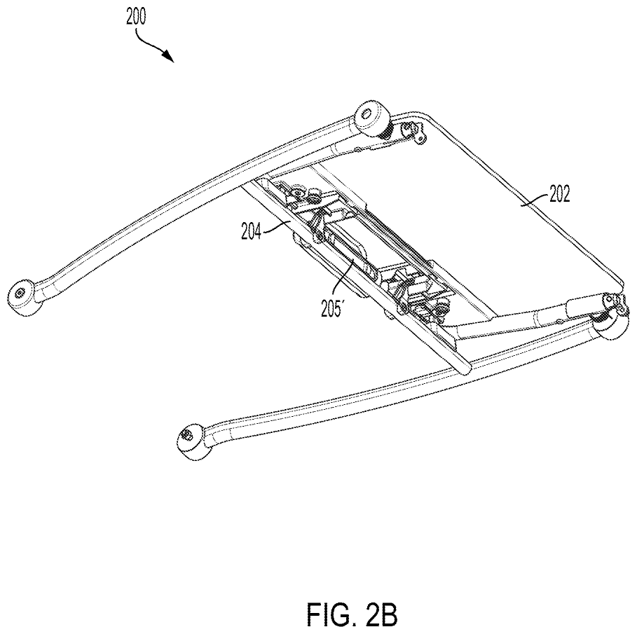

FIGS. 2A-B are renderings of a foldable seat assembly in accordance with embodiments of the invention. Turning now to FIG. 2A, perspective view of a foldable seat assembly is shown. The seat assembly 200 includes a seat back 201 and a seat bottom 202. The seat back 201 couples with the seat bottom 202 via screws, fasteners, hinges, or the like, so as to allow the seat back 201 and seat bottom 202 to remain coupled while moving about one another. A release handle 205 couples with the back of the seat bottom 202. In a variety of embodiments, the release handle 205 fits in a cutout on the seat bottom 202. In many embodiments, the release handle 205 can be actuated by the user by applying force in a direction such that the release handle 205 is pulled from the back of the seat bottom 202 towards the front of the bottom seat 202. In addition, the seat bottom 202 couples with a seat frame 203. The front left side of the seat frame 203 couples with a first end of a left bottom rod 206 via a lower fold point 207. Similarly, the front right side of the seat frame 203 couples with a first end of a right bottom rod 206 via a lower fold point 207. Moreover, a support crossbar 204 couples with the left and right bottom rods 206 via screws or fasteners, for example, such that a first end of the support crossbar 204 couples with one bottom rod 206 and a second end of the support crossbar 204 connects with a second bottom rod 206. The support crossbar 204 couples with the left and right bottom rods 206 such that it aligns with the rear of the seat frame 203. In several embodiments, the seat frame 203 lies on top of the support crossbar 204 and can rest on support members coupled with the support crossbar 204.

Turning now to FIG. 2B, an underside view of the seat assembly 200 with an alternative design for release handle 205′ is shown. As shown in FIG. 2B, the release handle 205′ fits in a cutout on the seat bottom 202 and has a slider that can be actuated by applying force in a direction such that the slider slides from the one left or right side of the seat bottom 202 towards the opposing left or right side of the bottom seat 202. Sliding the slider of release handle 205′ causes the release handle 205′ to disengage from the support crossbar 204, thereby allowing a stroller to convert from a deployed position to a collapsed position.

FIGS. 2A-B are illustrative embodiments of a foldable seat assembly and many configurations are appropriate. For example, a number of seat assemblies, including those that use alternative support crossbar placement, can be utilized as appropriate to the requirements of specific applications of embodiments of the invention.

### Release Handle Assemblies

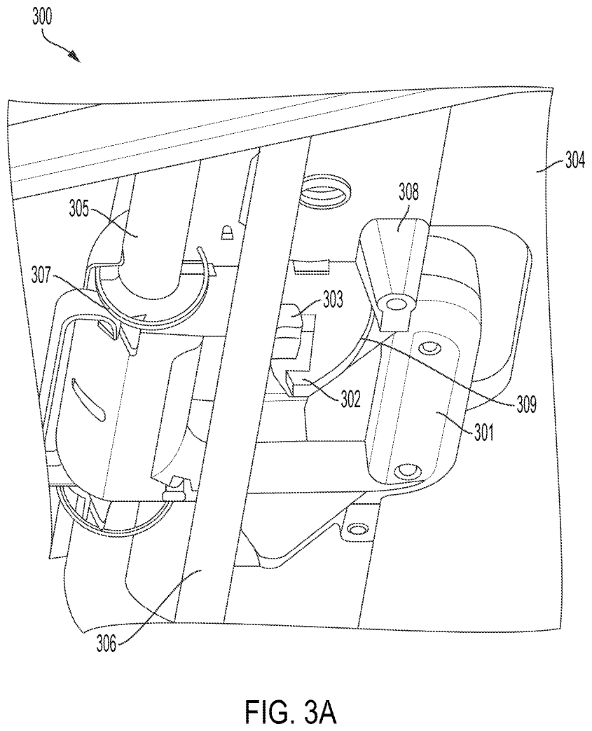

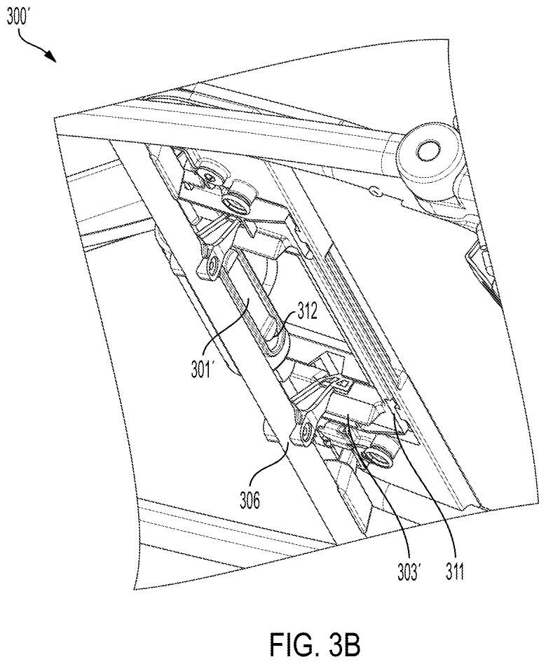

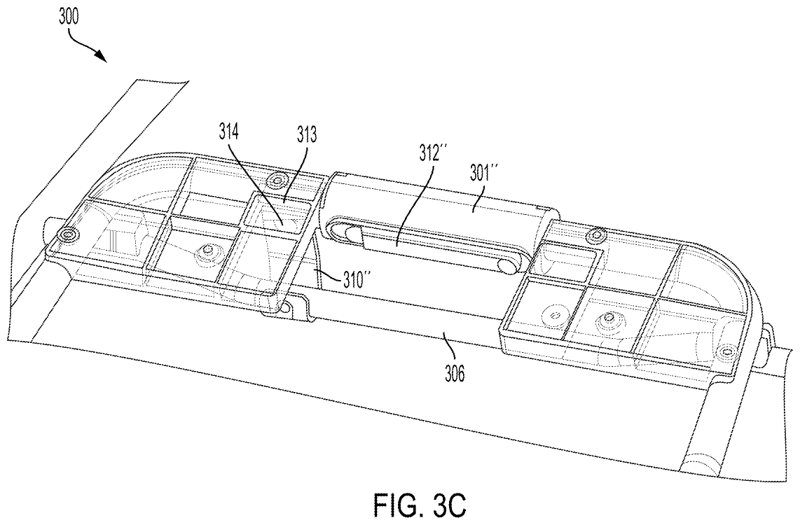

FIGS. 3A-C are renderings of release handle assemblies in accordance with embodiments of the invention. Turning now to FIG. 3A, perspective view of a release handle assembly 300 is shown. The release handle assembly 300 includes a release handle 301, a handle spring 307, and a seat slide member 308. The front of the release handle 301 can be accessed via an aperture in seat bottom 304. The back of the release handle 301 couples with a seat frame 305 so as to allow the release handle to move about the seat bottom 304. The handle spring 307 is coupled to seat frame 305 and the release handle 301 such that it creates tension that orients the release handle 301 in a rear-most position relative to the seat bottom 304. A user can direct force towards the front of the seat bottom 304 to overcome the tension created by the handle spring 307 and move the release handle 301 from a rear-most position to a front-most position.

The release handle 301 also includes left and right handle engaging members 302 which engage with left and right crossbar locking members 303 that are located on a support crossbar 306 that lies below the seat frame 305. When the release handle 301 is in the rear-most position, the handle engage members 302 mate with the crossbar locking members 303, thereby preventing the release handle 301 from moving in the up down direction, and locking it in place. When the user pulls the release handle 301, left and right handle ramp portions 309 on the release handle 301 interact with left and right seat slide members 308 coupled to the seat bottom 304. As a result, the release handle 301 is in the upward direction while the handle engage members 302 and crossbar locking members 303 disengage from each other.

Turning now to FIG. 3B, an underside view of a slide release handle assembly 300′ is shown. The slide release handle assembly 300′ includes a release handle 301′, a handle slide member 312, and slide lock 311. The handle slide member 312 slidably couples to the release handle 301′. The handle slide member 312 couples to a pair of slide locks 311. The slide locks 311 flank both sides of the release handle 301 and mate with corresponding crossbar locking members 303′ that are coupled to the support crossbar 306. In a variety of embodiments, the release handle 301′ includes a biasing member (not shown) that creates tension that orients the handle slide member 312 such that the slide locks 311 engage with the crossbar locking members 303′. A user can slide the handle slide member 312 to disengage the slide lock 311 from the crossbar locking members 303′.

Turning now to FIG. 3C, a perspective view a tab release handle assembly 300″ is shown. The tab release handle assembly 300″ includes a release handle 301″, a handle slide member 312″, a release tab 313, a locking tab 310″, and a rivet 314. The handle slide member 312″ slidably couples to the release handle 301″. The handle slide member 312″ couples to the release tab 313, which couples to the rivet 314. In a variety of embodiments, the release tab 313 is located near the rivet 314 and the locking tab 310″ couples to support crossbar 306. The locking tab 310″ has an engagement portion that aligns with the rivet 314. The locking tab 310″ is oriented such that it engages with the rivet 314. When the locking tab 310″ engages with the rivet 314, the release tab 313 contacts a portion of the locking tab 310″ near the rivet 314. A user can slide the handle slide member 312″, which moves the release tab 313, which disengages the locking tab 310″ from the rivet 314.

FIGS. 3A-C are illustrative embodiments of release handle assemblies in accordance with a variety of embodiments of the invention. However, it should be noted that many configurations are appropriate. For example, a number of handle assemblies, including those that use alternative crossbar locking member placement, can be utilized as appropriate to the requirements of specific applications of embodiments of the invention.

### Frame Hinge Assemblies

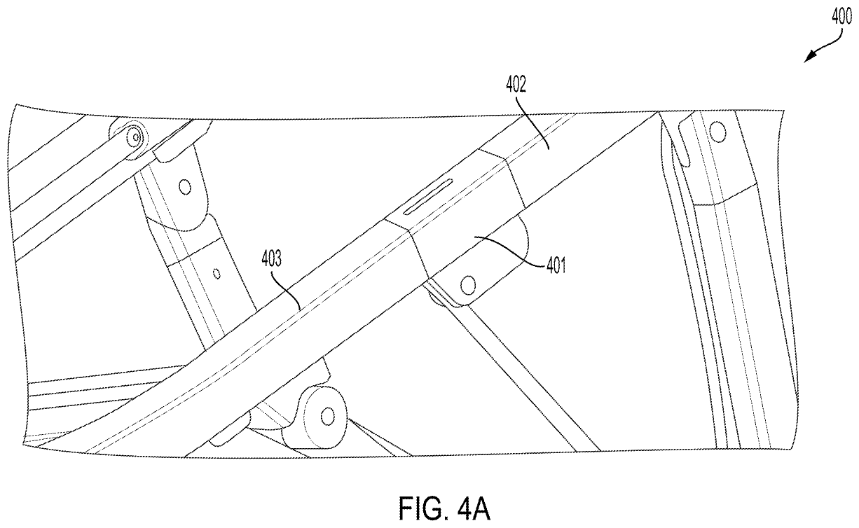

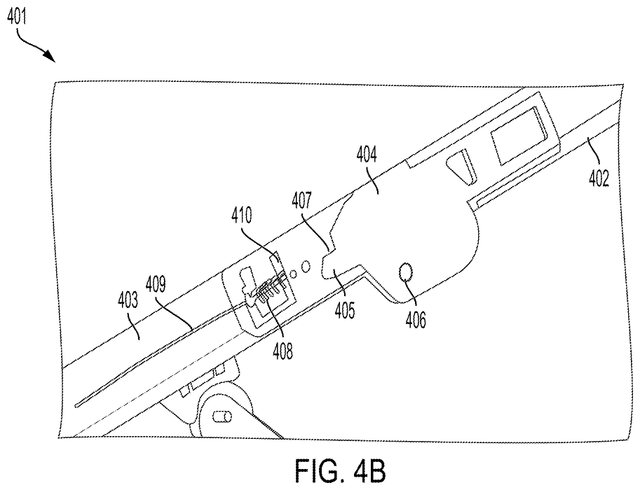

FIGS. 4A-B are renderings of a hinge assembly in accordance with embodiments of the invention. Turning now to FIG. 4A, a hinge assembly 400 is shown. The hinge assembly 400 includes a folding hinge 401 coupled to an upper member 402 and to a lower member 403. The upper member 402 and the lower member 403 can move relative to each other by way of the folding hinge 401.

Turning now to FIG. 4B, a cross-section of folding hinge 401 is shown. The folding hinge 401 includes a hinge plate 404, a movable member 410, and a spring 408. The hinge plate 404 couples with the upper member 402 and the movable member 410 couples with the lower member 403. The upper member 402 and lower member 403 pivot about the folding hinge 401 at the hinge pivot point 406. A cable 409 runs along the inside of the lower member 403 and couples with the movable member 410 on one end. In a variety of embodiments, the lower member couples with a release handle assembly via cable 409.

The hinge plate 404 has a blocking member protrusion 405 and the movable member 410 has a corresponding receiving member 407. When the blocking member 405 and the receiving member 407 engage, the upper member 402 and lower member 403 are locked in position relative to each other. The spring 408 in the movable member 410 creates tension that orients the movable member 410 such that the receiving member 407 mates with the blocking member 405 to lock the folding hinge 401 in an engaged position. In many embodiments, the folding hinge 401 can be disengaged by actuating a release handle assembly (not shown) that moves the wire 409 in a direction opposing the tension in the spring 408, thereby compressing the spring 408 and moving the movable member 410 in a direction away from the hinge plate 404. This causes the receiving member 407 to disengage from the blocking member 405. When the folding 401 is in the disengaged position, the upper member 402 and lower member 403 can move pivot about the hinge pivot point 406. In many embodiments, a stroller is in a deployed position when the folding hinge 401 is in the engaged position and the stroller is in a collapsed position when the folding hinge is in the disengaged position.

FIGS. 4A-B are illustrative embodiments of a hinge assembly and many configurations are appropriate. For example, a number of hinge assemblies, including those that use alternative receiving and blocking member placement, can be utilized as appropriate to the requirements of specific applications of embodiments of the invention.

### One-Hand Folding Action

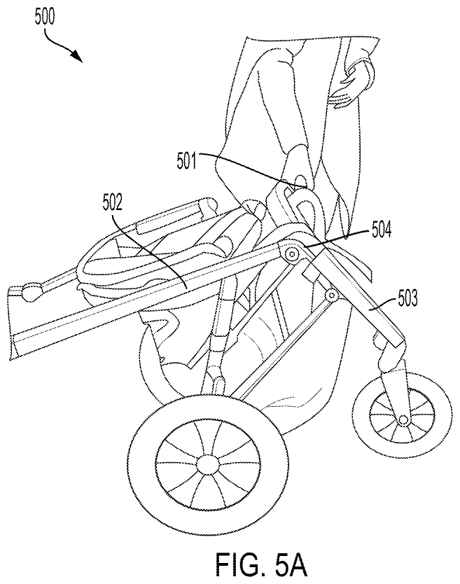

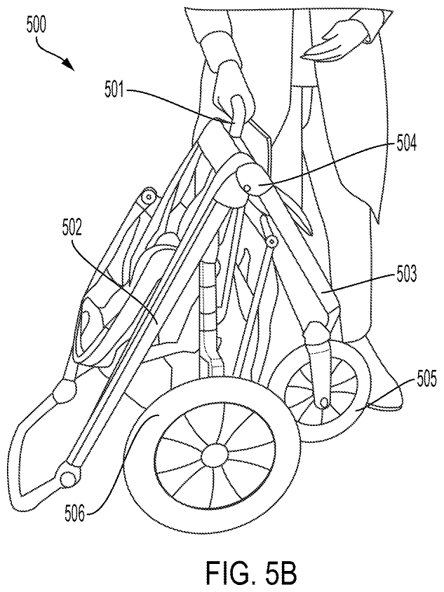

FIGS. 5A-B are photographs of a one-hand folding action for a one-hand folding stroller in accordance with embodiments of the invention. Turning now to FIG. 5A, a side view of a one-hand folding stroller 500 being collapsed is shown. To fold the stroller 500, the user actuates a release handle 501, which in turn unlocks folding hinge 504. When the folding hinge 504 unlocks, an upper member 502 and a lower member 503 move down and in towards one another, thereby allowing upper frame member 502 and lower frame member 503 to move relative to each other. As shown in FIG. 5A, the upper frame member 502 and lower frame member 503 are moving towards each other, thereby causing the stroller 500 to fold inwards towards itself along a central axis.

Turning now to FIG. 5B, a side view of the stroller 500 in the collapsed position is shown. In the collapsed position, the upper frame member 502 and the lower frame member 503 have moved towards each other and caused a front wheel 505 and rear wheels 506 move in towards the central axis. Further, as shown in FIG. 5B, the rear wheels 506 have retracted towards the central axis, thereby further reducing the footprint of the stroller 500 in the collapsed position.

FIGS. 5A-B are illustrative pictures of a one-hand folding stroller at various stages of one-hand folding action and many configurations are appropriate. For example, the upper and lower members can collapse to various angles as appropriate to the requirements of specific applications of embodiments of the invention.

### Release Handle Operation

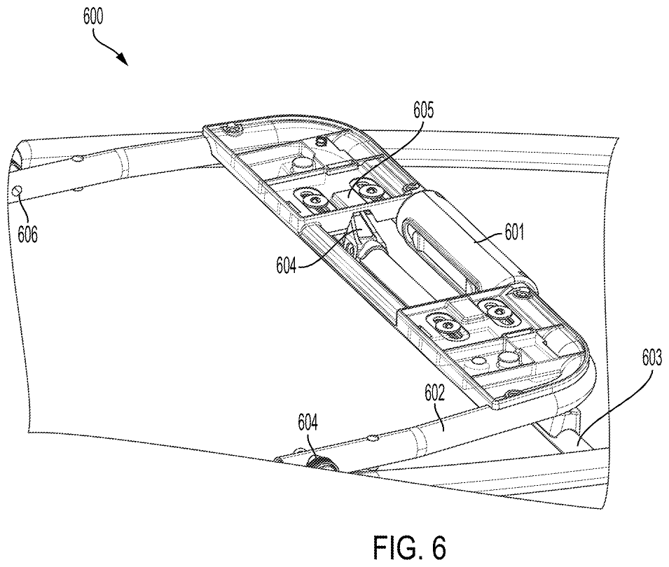

FIG. 6 is a rendering of the operation of a release handle for a one-hand folding stroller in accordance with embodiments of the invention. In FIG. 6, a perspective view of a slide release handle assembly 600 being disengaged is shown. When release handle 601 is actuated, slide locks 605 are disengaged from the crossbar locking members 604 as described herein. Once the slide locks 605 are disengaged, seat frame 602 can be disengaged from support crossbar 603 as described herein. Once disengaged, the seat frame 602 can be lifted to rotate about pivot points 606 in a direction away from support crossbar 603 as described herein.

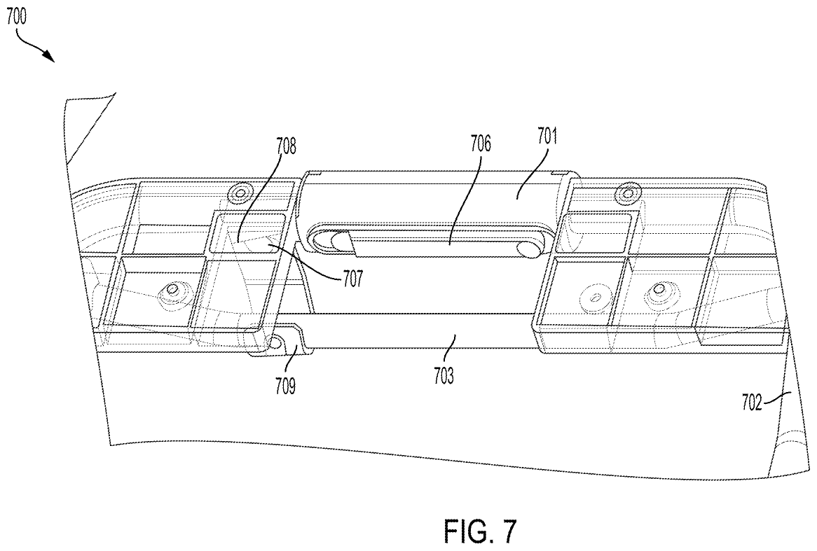

FIG. 7 is a rendering of the operation of a release handle for a one-hand folding stroller in accordance with embodiments of the invention. A tab release handle assembly 700 is shown in FIG. 7. Release handle 701 is actuated by sliding handle slide member 706. Slide member 706 is coupled with a release tab 708, which is located near a rivet 707. As the slide member 706 moves, it actuates the release tab 708, which engages with locking tab 709. The engagement of release tab 708 and locking tab 709 causes locking tab 709 to disengage from the rivet 707. Once disengaged, the seat frame 702 can be lifted to rotate about pivot points (not shown) in a direction away from support crossbar 703 as described herein.

FIGS. 6 and 7 are conceptual illustrations of the operation of a release handle in accordance with various embodiments of the invention. However, it should be noted that a variety of release handles, including those that disengage with frame members of the stroller, can be utilized as appropriate to the requirements of specific applications of embodiments of the invention.

Although the present invention has been described in certain specific aspects, many additional modifications and variations would be apparent to those skilled in the art. In particular, any of the various processes described above can be performed in alternative sequences and/or in parallel in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. It will be evident to the annotator skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled annotator, except where expressly required. Accordingly, the scope of the invention should be determined not by the embodiments illustrated, but by the appended claims and their equivalents.

What is claimed is:

1. A folding stroller comprising:
a collapsible frame;
at least one wheel in a front part of the collapsible frame;
at least one wheel in a rear part of the collapsible frame;
at least one folding hinge coupled to the collapsible frame;
a seating area having a seat portion and a back portion; and
a release handle in the seat portion of the seating area, the release handle configured to be actuated with a one hand action;
wherein the release handle is coupled to the at least one folding hinge;
wherein the release handle is accessible through the seating area; and
wherein actuating the handle causes the frame to transform from a deployed position to a collapsed position.

2. The folding stroller of claim 1, wherein:
the rear wheels are located a first distance from the frame when the frame is in a deployed position; and
the rear wheels are located a second distance from the frame in the collapsed position, where the second distance is less than the first distance.

3. The folding stroller of claim 1, wherein the seat portion of the seating area is coupled to the release handle.

4. The folding stroller of claim 3, wherein the release handle engages with the seating portion to lock the seating area in place.

5. The folding stroller of claim 1, wherein the collapsible frame comprises at least one folding hinge.

6. The folding stroller of claim 5, wherein the at least one folding hinge comprises a mating member and a hinge plate.

7. The folding stroller of claim 1, further comprising a slide lock, wherein the slide lock slidably couples to the release handle.

8. The folding stroller of claim 7, wherein the slide lock has a locked configuration where the slide lock engages with the release handle to prevent release handle actuation and the slide lock has an unlocked configuration where the slide lock does not engage with the release handle and does not prevent release handle actuation.

9. The folding stroller of claim 8, wherein the slide lock is toggled between the locked configuration and the unlocked configuration by sliding the slide lock from one side to another side.

10. The folding stroller of claim 1, further comprising a handle spring, wherein the handle spring couples to the release handle such that tension in the handle spring orients the release handle in a first position.

11. The folding stroller of claim 10, wherein the release handle is actuated by engaging the release handle at the first position to overcome the tension in the handle spring such that the release handle moves to a second position.

12. A folding stroller release handle assembly comprising:
a release handle coupled to a stroller seat frame;
a handle spring coupled to the stroller seat frame and the release handle; and
a handle lock;
wherein actuating the release handle causes the stroller seat frame to transform from a deployed position to a collapsed position.

13. The folding stroller release handle assembly of claim 12, wherein the release handle has a front portion and a rear portion.

14. The folding stroller release handle assembly of claim 13, wherein the front portion of the release handle can be accessed through an aperture in a seat bottom that is coupled to the stroller seat frame.

15. The folding stroller release handle assembly of claim 13, wherein the back portion of the release handle couples to the stroller seat frame so as to allow the release handle to move about a seat bottom that is coupled to the stroller seat frame.

16. The folding stroller release handle assembly of claim 15, wherein tension from handle spring orients the release handle in a rear-most position relative to the seat bottom, and wherein when the release handle is in the rear-most position relative to the seat bottom a set of handle engagement members in the release handle engage with the stroller seat frame so as to prevent the release handle from moving about the seat bottom.

17. The folding stroller release handle assembly of claim 16, wherein the release handle is actuated by engaging the release handle at the rear-most position relative to the seat bottom so as to overcome the tension in the handle spring such that the release handle moves to a front-most position relative to the seat bottom and concurrently the set of handle engagement members in the release handle disengage from the stroller seat frame such that the release handle can move about the seat bottom.

18. The folding stroller release handle assembly of claim 12, wherein the handle lock is a slide lock that has a locked configuration where the slide lock engages with the release handle to prevent release handle actuation and the slide lock has an unlocked configuration where the slide lock does not engage with the release handle and does not prevent release handle actuation.

19. The folding stroller of claim 18, wherein sliding the slide lock to a locked configuration prevents the release handle actuation.

20. A method for folding a foldable stroller comprising a collapsible frame, at least one wheel in a front part of the collapsible frame, at least one wheel in a rear part of the collapsible frame, at least one folding hinge coupled to the collapsible frame, a seating area having a seat portion and a back portion, and a release handle in the seat portion of the seating area, comprising:
actuating the release handle; and
pivoting the release handle about the collapsible frame such that the collapsible frame transforms from a deployed position to a collapsed position.
